(19) United States
(12) Patent Application Publication
(10) Pub. No.: US 2024/0238809 A1
(43) Pub. Date: Jul. 18, 2024

(54) CONVERGING-DIVERGING NOZZLE FOR HIGH-VELOCITY DISPENSING OF FIRE SUPPRESSANT

(71) Applicant: Kidde Technologies, Inc., Wilson, NC (US)

(72) Inventors: Eli Baldwin, Knightdale, NC (US); Saul Salas, Knightdale, NC (US)

(21) Appl. No.: 18/154,465

(22) Filed: Jan. 13, 2023

(51) Int. Cl. B05B 1/06; A62C 35/68

(52) U.S. Cl. CPC B05B 1/06; A62C 35/68; A62C 3/08

(57) ABSTRACT

A fire suppressant system, including: a nozzle having a passage wall that defines a converging-diverging passage, having: an inlet, an outlet downstream of the inlet, and a throat region that includes a converging portion and a diverging portion; a cone within the passage, having an upstream apex located within the diverging portion and a downstream end located within the passage and adjacent to the outlet, the cone has a radial outer wall that defines an exhaust passage with the passage wall, and the cone has a plurality of axial segments with differing segment cone angles, including: a first segment at the upstream apex of the cone that has a first cone angle such that the exhaust passage narrows along the first segment; and a second segment that is adjacent to the first segment and that has a second cone angle such that the exhaust passage expands along the second segment.

### BACKGROUND

The embodiments are directed to fire suppressant nozzles and more specifically to a converging-diverging nozzle for high-velocity dispensing of fire suppressant.

Achieving an efficient and robust dispersion of a dry chemical fire extinguishing agent throughout a designated fire zones (DFZs) in aircraft engine nacelles and auxiliary power units (APUs) can be challenging. A suppressant agent is generally stored with compressed gas in a bottle. A piping system connects the bottle to the DFZ. Upon discharge of the bottle, the compressed gas carries the agent through the piping system and sprays it into the DFZ. The agent aerosolizes and disperses throughout the DFZ. Standard cone nozzles result in rapidly expanding sprays that quickly mix with ambient air. Unlike gaseous agents, dry chemical agents tend to settle quickly and adhere to surfaces. This tendency to lose the agent to surfaces is exacerbated by the fact that DFZs are cluttered. Thus, efficiently delivering adequate concentrations of airborne agent throughout the DFZ may be challenging.

### BRIEF SUMMARY

Disclosed is a fire suppressant system, including: a nozzle having a passage wall that defines a converging-diverging passage, the passage having: an inlet, an outlet that is downstream of the inlet, and a throat region between the inlet and the outlet, the throat region including a converging portion and a diverging portion that is downstream of the converging portion; a cone within the passage, the cone having an upstream apex located within the diverging portion of the throat region and a downstream end located within the passage and adjacent to the outlet, wherein the cone has a radial outer wall that defines an exhaust passage between the radial outer wall of the cone and the passage wall, and wherein the cone has a plurality of axial segments with differing segment cone angles relative to each other, including: a first segment at the upstream apex of the cone that has a first cone angle such that the exhaust passage narrows along the first segment; and a second segment that is adjacent to the first segment and that has a second cone angle such that the exhaust passage expands along the second segment.

In addition to one or more of the above disclosed aspects of the system, or as an alternate, a transition between the first segment and the second segment is defined a convex shape.

In addition to one or more of the above disclosed aspects of the system, or as an alternate, a downstream end of the first segment of the cone defines a minimum flow area of the passage between the inlet and the outlet.

In addition to one or more of the above disclosed aspects of the system, or as an alternate, the passage wall further includes: an upstream section of the passage wall that extends between the inlet and the throat region and converges toward the throat region; and a downstream section of the passage wall that extends between the throat region and the outlet and diverges toward the outlet.

In addition to one or more of the above disclosed aspects of the system, or as an alternate, the downstream section of the passage wall defines a passage cone angle, wherein the passage cone angle, or a cone angle of the cone at the outlet of the passage, is between 15 and 60 degrees.

In addition to one or more of the above disclosed aspects of the system, or as an alternate, the upstream section of the passage includes first portion that extends from the inlet to an upstream transition location that is axially between the inlet and the throat region, and a second portion that extends from the upstream transition location to the throat region; the first portion of the upstream section is cylindrical; and the second portion of the upstream section converges toward the throat region.

In addition to one or more of the above disclosed aspects of the system, or as an alternate, the first portion of the upstream section of the passage is axially longer than the second portion such that the upstream transition location is closer to the throat region than to the inlet.

In addition to one or more of the above disclosed aspects of the system, or as an alternate, the system includes a source of suppressant that is a mixture of powder and gas, and the inlet of the nozzle is fluidly coupled to the source of suppressant.

In addition to one or more of the above disclosed aspects of the system, or as an alternate, the system includes another nozzle having a same configuration as the nozzle; and a piping system that fluidly couples the source of suppressant to the nozzle and the another nozzle.

In addition to one or more of the above disclosed aspects of the system, or as an alternate, the source of suppressant is pressurized to 800-10,000 psi and pressure at the outlet is atmospheric pressure or less.

In addition to one or more of the above disclosed aspects of the system, or as an alternate, suppressant flow at the inlet is between Mach 0.05 and Mach 0.2 and greater than Mach 2 at the outlet.

In addition to one or more of the above disclosed aspects of the system, or as an alternate, the suppressant flow in the throat region along the first segment of the cone approaches Mach 1, and the suppressant flow along the second segment of the cone is greater than Mach 1.

In addition to one or more of the above disclosed aspects of the system, or as an alternate, the suppressant flow isentropically increases flow speed above Mach 1.

In addition to one or more of the above disclosed aspects of the system, or as an alternate, powder of the suppressant flow is a dry chemical agent.

In addition to one or more of the above disclosed aspects of the system, or as an alternate, the gas of the suppressant flow is nitrogen, carbon dioxide or helium.

### BRIEF DESCRIPTION OF THE DRAWINGS

FIG. 1 shows a converging-diverging nozzle for dispensing fire suppressant according to an embodiment;

FIG. 2 shows a cross-section of the nozzle along line 2-2 of FIG. 1;

FIG. 3 shows a detail of a throat region of the nozzle identified in FIG. 2; and

FIG. 4 shows a system including a plurality of nozzles that are fluidly coupled to each other and a source of power suppressant and pressurized gas.

### DETAILED DESCRIPTION

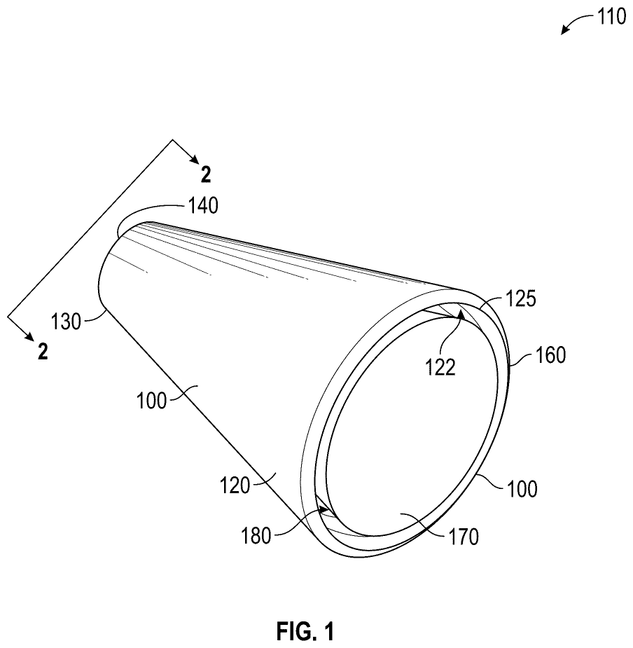

Turning to FIG. 1, a nozzle 100 of a fire suppressant system 110 is shown. The nozzle 100 has a nozzle housing or housing 120 that has an inner wall 122 that defines an internal exhaust passage (a passage) 125 with an upstream end 130 that is an inlet 140 to the passage 125 and a downstream end 150 that is an outlet 160 to the passage 125. A cone 170 is located within the housing 120. The cone 170 is solid with a radial outer wall 180 so that the passage 125 in the location of the cone 170 is formed between the outer wall 180 of the cone 170 and the inner wall 122 of the housing 120.

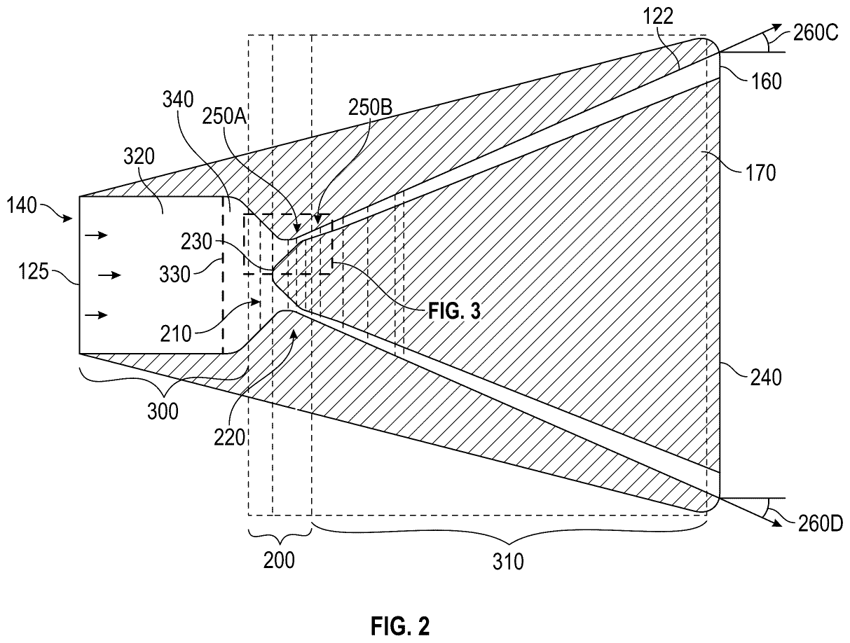

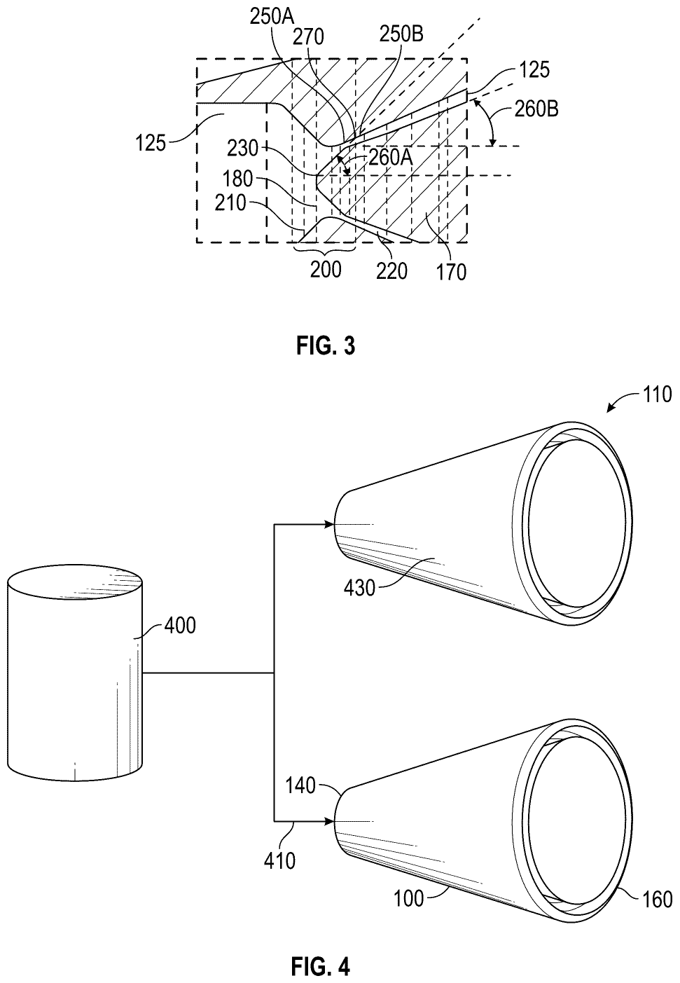

As shown in FIGS. 2 and 3, the passage 125 is a converging-diverging passage. Between the inlet 140 and the outlet 160, the passage has a throat region 200. The throat region 200 includes a converging portion 210 and a diverging portion 220 that is downstream of the converging portion 210.

The cone 170 has an upstream apex 230 located within the diverging portion 220 of the throat region 200. The cone 170 has a downstream end 240 (FIG. 2) located within the passage 125 and which is adjacent to the outlet 160. The cone 170 has a plurality of axial segments, generally referenced as 250. The segments 250 have differing segment cone angles, generally referenced as 260 (FIG. 3), relative to each other.

A first segment 250A of the cone 170 at the upstream apex 230 of the cone 170 has a first cone angle 260A such that the passage 125 narrows along the first segment 250A. A downstream end 270 (FIG. 3) of the first segment 250A of the cone 170 defines a minimum flow area of the passage 125 between the inlet 140 and the outlet 160. A second segment 250B is adjacent to the first segment 250A and has a second cone angle 260B such that the passage 125 expands along the second segment 250B. A transition between the first segment 250A and the second segment 250B along the outer wall 180 of the cone 170 may be defined a convex shape.

With further reference to FIG. 2, an upstream section 300 of the passage wall 122, e.g., the housing inner wall, extends between the inlet 140 and the throat region 200 and converges toward the throat region 200. A downstream section 310 of the passage wall 122 extends between the throat region 200 and the outlet and diverges toward the outlet 160. The downstream section 310 of the passage wall 122 defines a passage cone angle 260C. The passage cone angle 260C may differs from the first and second cone angles 260A, 260B to define the flow passage 125 between the passage wall 122 and the cone 170. The cone 170 of the passage wall 122 may be forty-five (45) degrees. Alternatively the cone angle 260D of the cone 170 at the outlet 160 of the nozzle 10 may be forty-five (45) degrees. Alternatively, these angles may range between zero (0) and ninety (90) degrees, and more preferably between fifteen (15) and sixty (60) degrees.

The upstream section 300 of the passage 125 includes first portion 320 that extends from the inlet 140 to an upstream transition location or generally an upstream transition 330 that is axially between the inlet 140 and the throat region 200. The first portion 320 of the upstream section 300 has a cylindrical cross section. The upstream section 300 includes a second portion 340 that extends from the upstream transition 330 to the throat region 200. The second portion 340 of the upstream section 300 converges toward the throat region 200. The first portion 320 of the upstream section 300 of the passage 125 is axially longer than the second portion 340 such that the upstream transition 330 is closer to the throat region 200 than to the inlet 140. This configuration provides for developing the flow conditions of the suppressant prior to reaching the throat region 200.

Turning to FIG. 4, the system 110 includes a source 400 of suppressant that is a mixture of powder and gas, and the inlet 140 of the nozzle 100 is fluidly coupled, e.g., by piping 410, to the source 400 of suppressant. The powder of the suppressant flow may be purple-K, sodium bicarbonate (also known as KSA), or any dry chemical agent. The gas of the suppressant flow may be nitrogen, carbon dioxide or helium. Typically, the dry powder agent and the charge gas are stored together in the same bottle. The gas occupies the head space and interstitial space between the particles of agent. Another nozzle 430 having a same configuration as the nozzle 100 is provided. A piping system 440 fluidly couples the source 400 of suppressant to the nozzle 100 and the another nozzle 430.

In operation, the source 400 of suppressant is pressurized approximately 800-30,000 psi, and in one embodiment approximately 800-10,000 psi, and in another embodiment to approximately 1500 psi and pressure at the outlet 160 is atmospheric pressure, or less if discharged at altitude of an aircraft in flight. The suppressant flow at the inlet 140 is between Mach 0.05 and Mach 0.2. Due to the design of the nozzle 100 the suppressant flow speed is approximately between Mach 2 and Mach 4 at the outlet 160. Though speed at the outlet is a function of the source pressure so that pressurizing the source to approximately 3000 psi may drive the outlet flow speed to greater than Mach 4. The suppressant flow in the throat region 200 along the first segment 250A of the cone 170 approaches Mach 1. The suppressant flow along the second segment 250B of the cone 170 becomes greater than Mach 1. The suppressant flow isentropically expands, increasing flow speed above Mach 1 due to the designed diverging flow passage area governed by the convex transition shape of the cone 170 in the throat region 200 and downstream of the throat region 200, as governed by the Prandtl-Meyer angle for flows above Mach 1, accounting for the heat capacity ratio of the suppressant. The shape of the passage 125 between the throat region 200 and the outlet 160 is similarly designed with a controlled rate of divergence to bring the flow to Mach 2 or above.

It is to be appreciated that the passage shape that results in increasing the flow above Mach 1 can be formed into the cone 170 as indicated above or in the passage wall 122, or in a combination between the cone 170 and passage wall 122. That is, arcuate contours of the second segment 250B of the throat region 200 and contours of the passage 125 through the outlet 160 that are required to obtain the targeted supersonic (Mach greater than unity) suppressant speed at the outlet 160 may be distributed between the cone 170 and passage wall 122, or be formed onto one of the cone 170 and passage wall 122.

Thus, the embodiments provide a converging diverging nozzle 100 that allows for a greater conversion of stored potential energy in the compressed gas to kinetic energy, resulting in higher spray velocities of the fire suppressant. The nozzle 100 produces a relatively high velocity spray that achieves better mixing and dispersion. The nozzle 100 directs the flow toward the cone 170 in a sub-sonic upstream flow section 300 of the nozzle 100. The flow is then accelerated to a sonic condition in a converging portion 210 of the nozzle throat region 200. The flow is further accelerated to a supersonic speed in a diverging portion 220 of the throat region 200. For example, control of the cone angle 260 can be achieved by manipulating the geometry of the nozzle 100 to provide a balance of spray penetration and mixing with a targeted diffusion rate. With the specific heat capacity ratio of the suppressant being a known value, a nozzle that funnels suppressant to Mach 1 can be configured by applying the Prandtl-Meyer angle to thereafter isentropically increase the flow above Mach 1 about a surface with convex transition zones. Thus, the rate of geometric convergence and divergence is tailored to the flow velocity requirements, accounting for an isentropic expansion factor of the suppressant as indicated.

Benefits of the embodiments include that the nozzle 100 more efficiently distributes fire suppressant due to a high velocity output. That is, a flow out of the nozzle 100, which has a high concentration of airborne agent, rapidly mixes with ambient air. The high velocity of the supplement reduces the tendency to settle onto surfaces.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A fire suppressant system, comprising:
a nozzle having a passage wall that defines a converging-diverging passage, the passage having:
an inlet, an outlet that is downstream of the inlet, and a throat region between the inlet and the outlet, the throat region including a converging portion and a diverging portion that is downstream of the converging portion;
a cone within the passage, the cone having an upstream apex located within the diverging portion of the throat region and a downstream end located within the passage and adjacent to the outlet, wherein the cone has a radial outer wall that defines an exhaust passage between the radial outer wall of the cone and the passage wall, and
wherein the cone has a plurality of axial segments with differing segment cone angles relative to each other, including:
a first segment at the upstream apex of the cone that has a first cone angle such that the exhaust passage narrows along the first segment; and
a second segment that is adjacent to the first segment and that has a second cone angle such that the exhaust passage expands along the second segment.

2. The system of claim 1, wherein:
a transition between the first segment and the second segment is defined a convex shape.

3. The system of claim 2, wherein:
a downstream end of the first segment of the cone defines a minimum flow area of the passage between the inlet and the outlet.

4. The system of claim 3, wherein the passage wall further comprises:
an upstream section of the passage wall that extends between the inlet and the throat region and converges toward the throat region; and
a downstream section of the passage wall that extends between the throat region and the outlet and diverges toward the outlet.

5. The system of claim 4, wherein:
the downstream section of the passage wall defines a passage cone angle,
wherein the passage cone angle, or a cone angle of the cone at the outlet of the passage, is between 15 and 60 degrees.

6. The system of claim 5, wherein:
the upstream section of the passage includes first portion that extends from the inlet to an upstream transition location that is axially between the inlet and the throat region, and a second portion that extends from the upstream transition location to the throat region;
the first portion of the upstream section is cylindrical; and
the second portion of the upstream section converges toward the throat region.

7. The system of claim 6, wherein:
the first portion of the upstream section of the passage is axially longer than the second portion such that the upstream transition location is closer to the throat region than to the inlet.

8. The system of claim 7, comprising:
a source of suppressant that is a mixture of powder and gas, and the inlet of the nozzle is fluidly coupled to the source of suppressant.

9. The system of claim 8, further comprising:
another nozzle having a same configuration as the nozzle; and
a piping system that fluidly couples the source of suppressant to the nozzle and the another nozzle.

10. The system of claim 9, wherein:
the source of suppressant is pressurized to 800-10,000 psi and pressure at the outlet is atmospheric pressure or less.

11. The system of claim 10, wherein:
suppressant flow at the inlet is between Mach 0.05 and Mach 0.2 and is greater than Mach 2 at the outlet.

12. The system of claim 11, wherein:
the suppressant flow in the throat region along the first segment of the cone approaches Mach 1, and the suppressant flow along the second segment of the cone is greater than Mach 1.

13. The system of claim 12, wherein the suppressant flow isentropically increases flow speed above Mach 1.

14. The system of claim 13, wherein the powder of the suppressant flow is a dry chemical agent.

15. The system of claim 14, wherein the gas of the suppressant flow is nitrogen, carbon dioxide or helium.
